(19) United States
(12) Patent Application Publication
(10) Pub. No.: US 2015/0254789 A1
(43) Pub. Date: Sep. 10, 2015

(54) SYSTEM AND METHOD FOR PROVIDING AN ADAPTIVE MENU

(71) Applicants: Ken Neeld, Newport Coast, CA (US); Bill Homan-Muise, Costa Mesa, CA (US); Mark DiCamillo, Dove Canyon, CA (US)

(72) Inventors: Ken Neeld, Newport Coast, CA (US); Bill Homan-Muise, Costa Mesa, CA (US); Mark DiCamillo, Dove Canyon, CA (US)

(73) Assignee: DELPHI DISPLAY SYSTEMS, INC., Costa Mesa, CA (US)

(21) Appl. No.: 14/639,833

(22) Filed: Mar. 5, 2015

Related U.S. Application Data
(60) Provisional application No. 61/948,263, filed on Mar. 5, 2014.

(51) Int. Cl. G06Q 50/12; G06Q 20/32; G06Q 30/06

(52) U.S. Cl. CPC G06Q 50/12; G06Q 30/0631; G06Q 30/0643; G06Q 20/3278; G06Q 20/3274

(57) ABSTRACT

A computer-implemented platform and methods of use are disclosed that provide networked access to a plurality of information, including but not limited to customer preference data and digital representations of products and menu items.

### CROSS-REFERENCE TO RELATED APPLICATIONS

This application claims priority to U.S. Provisional Patent Application No. 61/948,263, filed Mar. 5, 2014, the entirety of which is incorporated herein by reference.

### FIELD OF THE INVENTION

The present invention relates to electronic digital adaptive menu systems for customers to order from while remaining in their motor vehicle.

### BACKGROUND OF THE INVENTION

It is common for banks, pharmacies and restaurants to have “drive-thru” service lanes where customers can drive in, order their product or service, and have it delivered to them without leaving their vehicle. In particular restaurants accomplish this with multi-station drive thru lanes. One station may be for viewing the menu and placing the order, another may be for paying for the order, and yet another may be for picking up the purchased merchandise. Convenience and speed are the primary benefits of drive thru lane ordering and pickup.

In particular, speed of service delivery is one of the primary goals for the quick service restaurant industry. The faster that orders can be processed the greater the sales volume that can be generated. There are several tasks that make up the majority of the time for delivering such services. These include, defining the customer order, cooking and assembling the customer order, taking payment and delivering the ordered items to the customer's vehicle.

As quick service restaurant menus have been expanded and become more complex, the time it takes for the customer to define their order for the order taker has expanded greatly. There is a need in the market to automatically change and update the content of the menu to facilitate ordering for each specific customer.

Thus, there is a need in the market to provide more efficient and cost effective menu ordering systems in quick service restaurants.

### SUMMARY

The adaptive digital menu board system may use some mechanism for the consumer to identify themselves at the order point. The adaptive menu system may query its local data to find that customer's preferences, including favorite, most frequent and last ordered menu items, for example. If no information is found locally, the system may also query other remote systems for the customer profile. The adaptive menu system may automatically change its display to highlight the appropriate menu items.

In addition, the adaptive digital menu board system may provide feedback to the user as they define their order to the remote order taker. This feedback may take the form of special highlights next to menu items, or a form of dynamic digital order receipt that is built on the menu board as the order is being defined.

Speed of ordering may be increased by making the items they are most likely to order easy to find and prominently displayed. Speed may also be improved by showing the customer what they have ordered in real time as they order it.

It is to be understood that both the foregoing general description and the following detailed description are exemplary and explanatory, and are intended to provide further explanation of the invention as discussed hereinthroughout.

### BRIEF DESCRIPTION OF THE DRAWINGS

The accompanying drawings are included to provide a further understanding of the disclosed embodiments. In the drawings:

FIG. 1 is an illustration of a customer approaching the digital menu board system in their vehicle, and using data sent wirelessly from a mobile phone or tablet device to identify the customer;

FIG. 2 illustrates how a customer ID might be encoded in a QR Code on the customer's mobile phone screen and the screen might be read by a camera in the digital menu board system;

FIG. 3 illustrates how the digital menu board system might automatically updates to change from burgers to salads for a customer identified with vegetarian food preferences;

FIG. 4 illustrates how the digital menu board system might automatically change to use a portion of the screen to show what the customer has ordered so far in this transaction;

FIG. 5 illustrates an alternative display that might be used to show which items have been ordered by placing a check mark with the quantity ordered next to the item on the menu display; and

FIG. 6 illustrates a communication system for use with the present invention.

FIG. 7 Illustrates the software and data process flow that takes a customer identification, maps it to the customer preferences, and then dynamically places items on the menu based on the customer's preferences.

### DETAILED DESCRIPTION

A computer-implemented platform and methods of use are disclosed that provide networked access to a plurality of information, including but not limited to customer preference data and digital representations of products and menu items. The described embodiments are intended to be exemplary and not limiting. As such, it is contemplated that the herein described systems and methods can be adapted to provide many types of adaptive menu and ordering systems, and can be extended to provide enhancements and/or additions to the exemplary services described. The invention is intended to include all such extensions. Reference will now be made in detail to various exemplary and illustrative embodiments of the present invention.

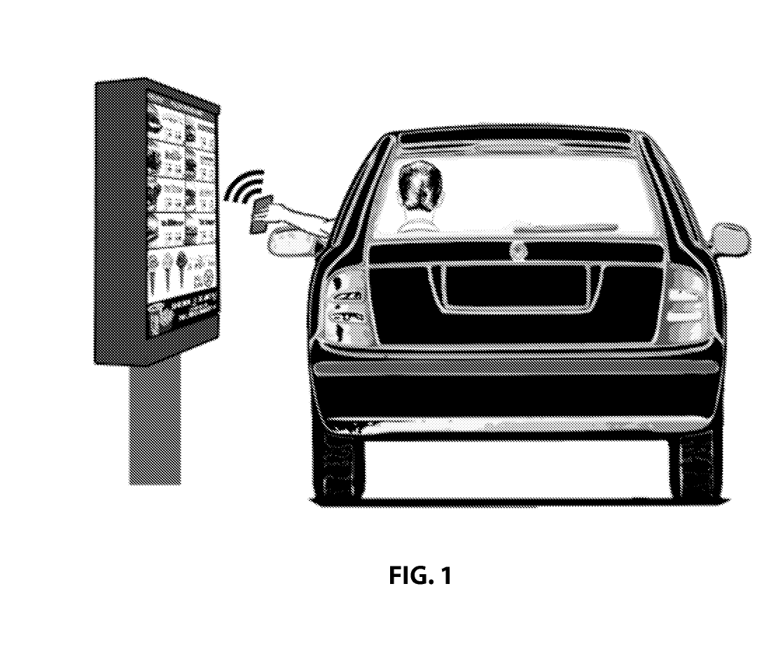

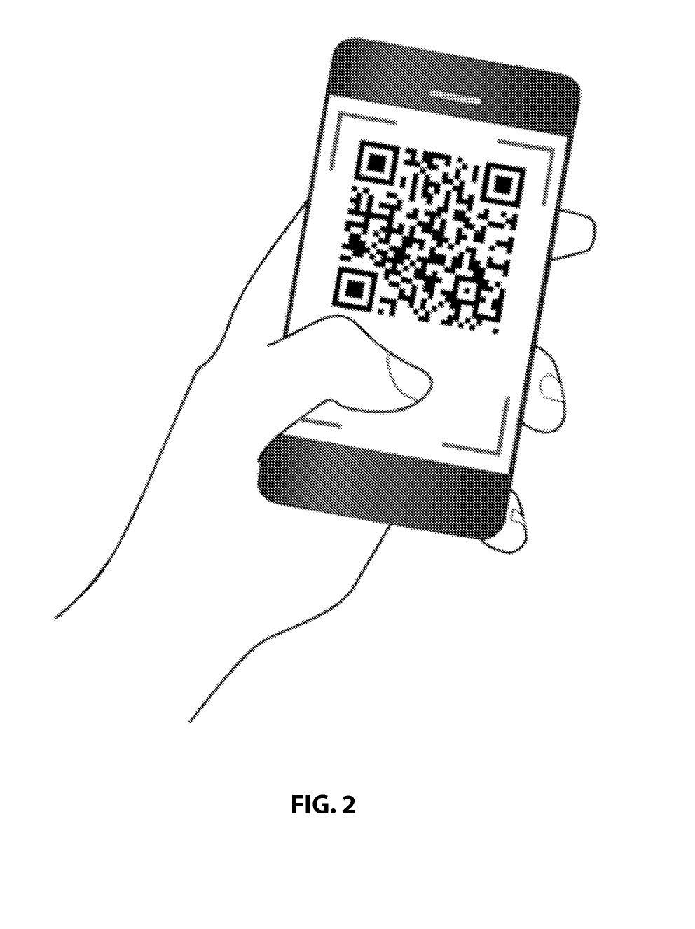

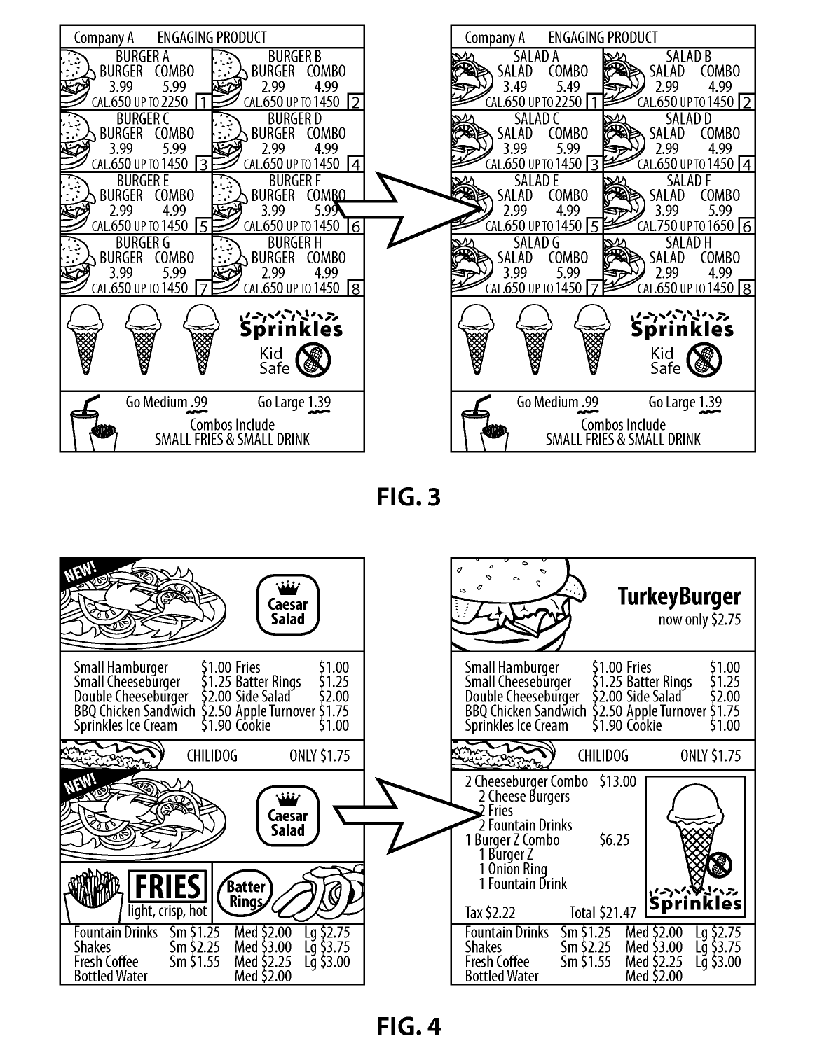

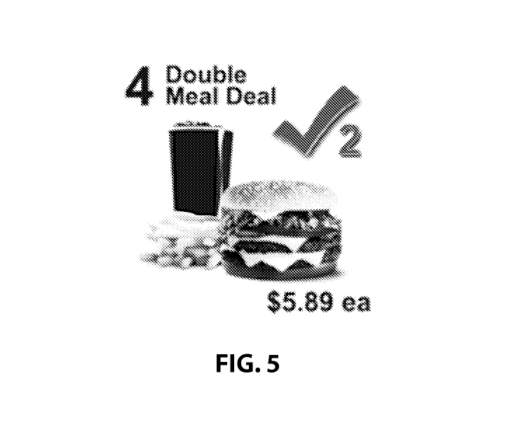

Information about the customer's preferences will be collected and stored in the adaptive digital adaptive menu system invention. This information can be collected in a variety of ways, including records of past orders made through this adaptive menu system, records of past orders made at other locations that also use this adaptive menu system, records of previous orders made for customers that have a profile similar to the current customer, and by preferences previously indicated by the customer through, for example, a loyalty program. As illustrated in FIG. 1, a customer may use their mobile phone to transmit their customer ID via radio transmission such as Near Field Communication (NFC), Bluetooth or other means of transmission.

The adaptive menu system will include a customer identification system to identify the customer that is situated before it through any number of mechanisms including, reading a code from an RFID tag placed on the customer's vehicle, by near field or blue tooth radio link to the customer's mobile device, by reading a visual representation of a QR or bar code displayed on the screen of the customer's mobile device that is shown to a camera on the adaptive menu system.

The adaptive menu system will look up the customer's preferences based on the customer ID obtained by the customer identification system, as illustrated in FIG. 7 (200). The adaptive menu system will first query its own local data storage for any records relating to this particular customer. If no record of the customer is found, the adaptive menu system may also query other remote systems for additional data about this particular customer.

The adaptive menu system may send the found customer preference profile FIG. 7 (230) to the preference ranking engine (250).

Based on the data provided and retrieved, the adaptive menu system will automatically and dynamically change its content and display layout to best serve the needs of the current customer. Various algorithms in the adaptive menu system will be used to rank the available menu items based on the customer's preferences, and create an ordered list FIG. 7 (280). The adaptive menu system adaptive menu designer will dynamically layout the menu items in rank order, highlighting various menu items and placing them in the most prominent position on the menu. For example as depicted in FIG. 7, the menu item with the “#1” ranking (280) is displayed in the most prominent menu location “A” (290), in similar fashion the menu item with the “#2” rank is displayed in the second-most prominent menu location “B”. This process continues until all the locations on the menu have been filled with the menu items in ranked order. In this way, as an example, some items might be expanded to include a full graphic image or video to highlight that item, while others may be reduced to a simple text line item. By way of further example, a vegetarian might only prominently be shown salads with vivid images and videos, while other meat menu items like burgers are reduced to simple text menu line items.

By prominently displaying the most likely ordered items, on the menu, the customer would be able to more quickly define their order without having to waste time searching for the items they want to purchase. In addition, the adaptive menu system might also be used to recommend items that might highly interest that customer (or similar customers) and that have an additional benefit, such as increased revenue or profit for the store owner. Once the customer has left the menu, the menu would revert back to its default, standard layout menu items.

The adaptive menu system would further increase speed and accuracy of the order by dynamically in near real time reporting back to the customer what they have ordered. This dynamic feedback would be displayed on the digital menu board screen, and could take the form of highlighting the actual menu items as they are ordered by adding a glow or check mark next to them, or by including a dynamic receipt that is built as each new item is added to the order. The receipt would be displayed in a section of the digital menu board for the customer to view.

When the order is complete, the adaptive digital menu board system would store the results of the order including metrics such as the customer ID, the items highlighted, the items the store suggested they purchase, the number of suggestions that were successfully purchased, and the details of what were ultimately purchased. The adaptive digital menu board system would apply algorithms to this data to update the customer preference profile and store it for access during a future visit.

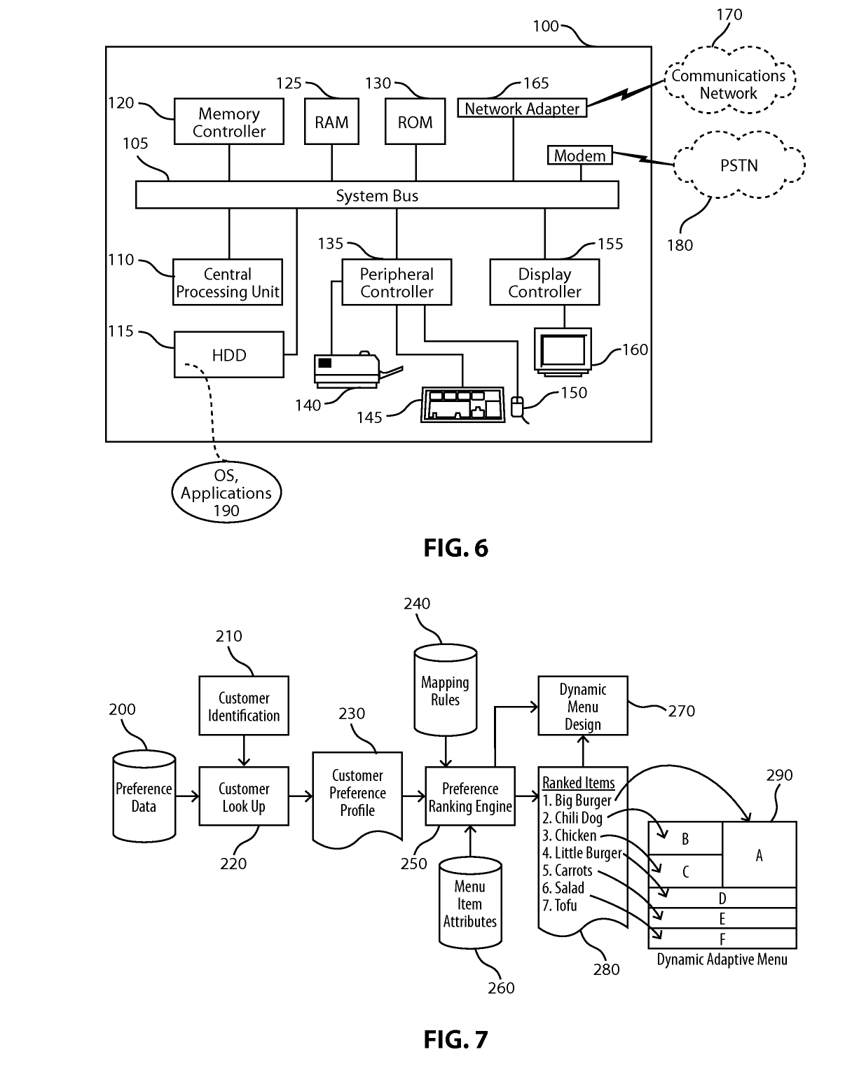

FIG. 6 depicts an exemplary computing system 100 for use in accordance with herein described system and methods. Computing system 100 is capable of executing software, such as an operating system (OS) and a variety of computing applications 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use a system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output and/or presentation generated by or at the request of computing system 100. Such visual output may include text, graphics, animated graphics, and/or video, for example. Display 160 may be implemented with a CRT-based video display, an LCD-based flat-panel display, gas plasma-based flat-panel display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet. Communications network 170 may provide user access for computing system 100 with means of communicating and transferring software and information electronically. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

Those of skill in the art will appreciate that the herein described systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the invention and its equivalents.

What is claimed is:

1. A system for identifying a customer in a vehicle, comprising:
at least one camera communicatively connected to at least one network hub for capturing at least one image of a passing vehicle;
a digital menu board for displaying menu items;
a local data storage which contains information on a plurality of customers and a plurality of customer preferences;
wherein the at least one image is compared to ones of the plurality of known images for the identification of at least one prior passing vehicle;
wherein a customer is identified based on the identified vehicle; and
wherein the digital menu is automatically and dynamically changed based on the identified customer.

2. The system of claim 1, wherein the camera captures at least one image by reading a visual representation of a QR or bar code displayed on a mobile device.

3. The system of claim 1, wherein a wireless Near Field Communication NFC radio receiver/transmitter reads a code from an RFID tag placed on the vehicle or chip contained in the customer's mobile phone or tablet.

4. The system of claim 1, wherein a wireless Blue Tooth radio receiver/transmitter reads a code from an electronic device located in the vehicle.

5. The system of claim 1, wherein the identified customer is associated with a customer ID.

6. The system of claim 5, wherein a local data storage is queried using the customer ID to retrieve customer preference records.

7. The system of claim 6, querying a remote data storage for customer preference records when the local data storage returns no results.

8. The system of claim 7, wherein the displayed menu items are ranked based on the customer preference records.

9. The system of claim 7, where some menu items are dynamically displayed more prominently than others based on customer preference records.

10. The system of claim 1, wherein the digital menu board provides dynamic feedback during an ordering process.

11. The system of claim 10, wherein the dynamic feedback includes highlighting menu items by adding a glow or check mark next to ordered items.

12. The system of claim 10, wherein the system dynamically updates a portion of the menu display with a receipt list of the items already ordered.

13. A method for identifying a customer in a vehicle, comprising:
at least one camera communicatively connected to at least one network hub for capturing at least one image of a passing vehicle;
a digital menu board for displaying menu items;
a local data storage which contains information on a plurality of customers and a plurality of customer preferences;
wherein the at least one image is compared to ones of the plurality of known images for the identification of at least one prior passing vehicle;
wherein a customer is identified based on the identified vehicle; and
wherein the digital menu is automatically and dynamically changed based on the identified customer.

14. The method of claim 13, wherein the camera captures at least one image by reading a visual representation of a QR or bar code displayed on a mobile device.

15. The method of claim 13, a wireless Near Field Communication NFC radio receiver/transmitter reads a code from an RFID tag placed on the vehicle or from a chip contained in the customer's mobile phone or tablet.

16. The method of claim 13, wherein a wireless Blue Tooth radio receiver/transmitter reads a code from an electronic device located in the vehicle.

17. The method of claim 13, wherein the identified customer is associated with a customer ID.

18. The method of claim 17, wherein a local data storage is queried using the customer ID to retrieve customer preference records.

19. The method of claim 18, querying a remote data storage for customer preference records when the local data storage returns no results.

20. The method of claim 19, wherein the displayed menu items are ranked based on the customer preference records.

21. The method of claim 19, where some menu items are displayed more prominently than others based on customer preference records.

22. The method of claim 13, wherein the digital menu board provides dynamic feedback during an ordering process.

23. The method of claim 22, wherein the dynamic feedback includes highlighting menu items by adding a glow or check mark next to ordered items.

24. The method of claim 22, wherein the method dynamically updates a portion of the menu display with a receipt list of the items already ordered.
